(19) United States
(12) Patent Application Publication
(10) Pub. No.: US 2009/0110859 A1
(43) Pub. Date: Apr. 30, 2009

(54) POLY(HYDROXYALKANOIC ACID) COMPOSITION

(75) Inventors: Douglas S. Larson, JR., Wilmington, DE (US); Julius Uradnisheck, Glen Mills, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/262,720

(22) Filed: Oct. 31, 2008

Related U.S. Application Data
(60) Provisional application No. 60/983,965, filed on Oct. 31, 2007.

(51) Int. Cl. B32B 1/08; C08F 220/06; B29C 45/00; C08J 5/00

(52) U.S. Cl. 428/36.9; 525/190; 428/35.7; 264/328.17; 264/331.18

(57) ABSTRACT

Disclosed is a composition comprising poly(hydroxyalkanoic acid) and an impact modifier having repeat units derived from an alkyl acrylate and optionally a comonomer. Also disclosed is a process for producing the composition and an article comprising the composition.

The application claims priority to U.S. provisional application Ser. No. 60/983965, filed Oct. 31, 2007; the entire disclosure of which is incorporated herein by reference.

The invention relates to a poly(hydroxyalkanoic acid) composition comprising an impact modifier and to a transparent article comprising the composition.

### BACKGROUND OF THE INVENTION

Poly(hydroxyalkanoic acid) (PHA) such as polylactic acid (PLA) is a resin comprising renewable monomer can be produced by bacterial fermentation processes or isolated from plant matter that include corn, sugar beets, or sweet potatoes. The resin can be used for making clear thermoformed packaging articles such as cups, trays, and clam shells. Generally, the resin is first extruded into an amorphous sheet and formed above the glass transition temperature into an amorphous or semi-crystalline but transparent finished article.

However, physical limitations such as brittleness may prevent easy thermoforming, or injection molding of, PHA into articles that have an acceptable degree of toughness for many applications. Extruded amorphous sheeting may also be too brittle for handling in continuous moving equipment without breakage such as during edge-trimming or pinning.

Impact modifiers for producing a toughened PLA article include those disclosed in U.S. Pat. No. 6,417,294, U.S. Pat. No. 6,803,443, U.S. Pat. No. 6,943,214, and JP H9-316310. Because of the environmental value of its biodegradability and its sustainability of raw materials, there is constant need to improve a PHA composition that can be processed into a variety of articles with an acceptable level of toughness and optical clarity.

### SUMMARY OF THE INVENTION

An article comprises or is produced from a composition comprising, consisting essentially of, or consisting of, poly(hydroxyalkanoic acid) (PHA) and one or more impact modifiers wherein the modifier comprises, repeat units derived from an alkyl acrylate and a comonomer.

A process comprises contacting a PHA composition or PHA with an impact modifier to produce a compound; thermoforming the compound into a mold at a temperature of from about 15° C. below the average of glass transition temperature (T_{g}) and melting point (Tₘₑₗₜ), of the PHA, to about 20° C. above the average of T_{g} and Tₘₑₗₜ to produce a thermoformed article; optionally heat setting the article by holding the article in a dimensionally constrained manner at a temperature above T_{g}; cooling the article below the Tg; and recovering the thermoformed article.

### DETAILED DESCRIPTION OF THE INVENTION

PHA compositions include polymers comprising repeat units derived from one or more hydroxyalkanoic acids having 2 to 15, 2 to 10, 2 to 7, or 2 to 5, carbon atoms. Examples include glycolic acid, lactic acid, 3-hydroxypropionate, 2-hydroxybutyrate, 3-hydroxybutyrate, 4-hydroxybutyrate, 3-hydroxyvalerate, 4-hydroxyvalerate, 5-hydroxyvalerate, 6-hydroxyhexanoic acid, 3-hydroxyhexanoic acid, 4-hydroxyhexanoic acid, 3-hydroxyheptanoic acid, or combinations of two or more thereof. Examples of polymers include poly(glycolic acid) (PGA), poly(lactic acid) (PLA) and poly(hydroxybutyrate) (PHB), polycaprolactone (PCL), or combinations of two or more thereof, including blends of two or more PHA polymers (e.g., blend of PHB and PCL) that are desirably not amorphous.

PHA can be produced by bulk polymerization. A PHA may be synthesized through the dehydration-polycondensation of the hydroxyalkanoic acid. A PHA may also be synthesized through the dealcoholization-polycondensation of an alkyl ester of polyglycolic acid or by ring-opening polymerization of a cyclic derivative such as the corresponding lactone or cyclic dimeric ester. The bulk polymerization can be carried out by two production processes, i.e., a continuous process and a batch process. Japanese patent application JP03-502115A discloses a process wherein bulk polymerization for cyclic esters is carried out in a twin-screw extruder. JP07-26001A discloses a process for the polymerization for biodegradable polymers, wherein a bimolecular cyclic ester of hydroxycarboxylic acid and one or more lactones are continuously fed to a continuous reaction apparatus having a static mixer for ring-opening polymerization. JP07-53684A discloses a process for the continuous polymerization for aliphatic polyesters, wherein a cyclic dimer of hydroxycarboxylic acid is fed together with a catalyst to an initial polymerization step, and then continuously fed to a subsequent polymerization step built up of a multiple screw kneader. U.S. Pat. No. 2,668,162 and U.S. Pat. No. 3,297,033 disclose batch processes.

PHA also includes copolymers comprising more than one PHA, such as polyhydroxybutyrate-hydroxyvalerate (PHBN) copolymers and copolymers of glycolic acid and lactic acid (PGA/LA). Copolymers can be produced by copolymerization of a polyhydroxyalkanoic acid or derivative with one or more cyclic esters and/or dimeric cyclic esters. Such comonomers include glycolide (1,4-dioxane-2,5-dione), dimeric cyclic ester of glycolic acid, lactide (3,6-dimethyl-1,4-dioxane-2,5-dione), α,α-dimethyl-β-propiolactone, cyclic ester of 2,2-dimethyl-3-hydroxypropanoic acid, β-butyrolactone, cyclic ester of 3-hydroxybutyric acid, δ-valerolactone, cyclic ester of 5-hydroxypentanoic acid, ε-caprolactone, cyclic ester of 6-hydroxyhexanoic acid, and lactone of its methyl substituted derivatives, such as 2-methyl-6-hydroxyhexanoic acid, 3-methyl-6-hydroxyhexanoic acid, 4-methyl-6-hydroxyhexanoic acid, 3,3,5-trimethyl-6-hydroxyhexanoic acid, etc., cyclic ester of 12-hydroxy-dodecanoic acid, and 2-p-dioxanone, cyclic ester of 2-(2-hydroxyethyl)-glycolic acid, or combinations of two or more thereof.

PHA compositions also include copolymers of one or more PHA monomers or derivatives with other comonomers, including aliphatic and aromatic diacid and diol monomers such as succinic acid, adipic acid, and terephthalic acid and ethylene glycol, 1,3-propanediol, and 1,4-butanediol. About 100 different comonomers have been incorporated into PHA polymers. Generally, copolymers having the more moles of comonomer(s) incorporated, the less likely the resulting copolymer is to crystallize.

PHA polymers and copolymers may also be made by living organisms or isolated from plant matter including Azotobacter, Alcaligenes latus, Comamonas testosterone and genetically engineered E. coli and Klebsiella. U.S. Pat. No. 6,323,010 discloses a number of PHA copolymers prepared from genetically modified organisms.

PLA includes poly(lactic acid) homopolymers and copolymers of lactic acid and either non-isomers or optical isomers (stereo-isomers) containing at least 50 mole % (50% comonomer gives the least likely copolymer composition to crystallize, no matter what conditions) of repeat units derived from lactic acid or its derivatives (mixtures thereof) having a number average molecular weight of 3000 to 1000000, 10000 to 700000, or 20000 to 300000. PLA may contain at least 70 mole % of repeat units derived from (e.g. made by) lactic acid or its derivatives. The lactic acid monomer for PLA homopolymers and optical copolymers can be derived from d-lactic acid, I-lactic acid, or combinations thereof. A combination of two or more PLA polymers can be used. PLA may be produced by catalyzed ring-opening polymerization of the dimeric cyclic ester of lactic acid, which is frequently referred to as “lactide.” As a result, PLA is also referred to as “polylactide.”

PLA also includes the special class of copolymers and blends of different stereo-isomers of lactic acid or lactide. Melt blends of PLA polymerized from d-lactic acid or d-lactide and PLA polymerized from I-lactic acid or I-lactide can give a stereo-complex between the two stereopure PLAs at a 50/50 ratio. Crystals of the stereo-complex itself has a much higher melt point than either of the two PLA ingredients. Similarly stereo-block PLA can be solid state polymerized from low molecular weight stereo-complex PLA.

Copolymers of lactic acid are typically prepared by catalyzed copolymerization of lactic acid, lactide or another lactic acid derivative with one or more cyclic esters and/or dimeric cyclic esters as described above.

PHA may comprise up to about 99.8 weight %, of the composition, based on the total amount of PHA and modifier used. For example, the PHA may be present in a range from a lower limit of about 96 to 100 weight %.

The PHA composition may comprise about 0.1 to about 50%, about 0.5 to about 40%, about 1 to about 30%, about 2 to about 30%, about 3 to about 20%, or about 5 to about 10%, based on the weight of the composition, of an impact modifier. The modifier comprises, consists essentially of, or consists of repeat units derived from an alkyl acrylate and a comonomer. Repeat units derived from alkyl acrylate and the comonomer may each comprise, based on the modifier weight, from about 5, 10, 20, 40 or 50% to about 50, 60, 80, 90 or 95%. The alkyl can include 1 to about 10 or 2 to about 10 carbon atoms per group such as ethyl acrylate, propyl acrylate, isopropyl acrylate, n-butyl acrylate, tert-butyl acrylate, iso-butyl acrylate, sec-butyl acrylate, amyl acrylate, or combinations of two or more thereof. The comonomer can include (meth)acrylic acid, maleic acid, maleic anhydride, epoxy (meth)acrylate (e.g., glycidyl methacrylate and glycidyl acrylate), carbon monoxide, or combinations of two or more thereof. The acid moiety, or portion thereof, of the modifier can be neutralized with a metal ion such as Na, K, Mg, Zn, or combinations of two or more thereof.

The modifier can be available commercially (e.g., Aldrich Chemical Company, Milwaukee, Wis.) or produced by any processes known to one skilled in the art such as radical polymerization. For example, the impact modifier can be produced by mixing the alkyl acrylate and comonomer in the weight % ranges disclosed above in any suitable vessels or reactors, optionally in the presence of about 0.1 to about 10 weight % of a polymerization initiator and an optional additive disclosed below in a solvent to produce a solution or a suspension for a time sufficient (e.g., from 1 minute to 20 hours) at a temperature from 25° C. to about 250° C. at atmospheric pressure to any pressure that accommodates the temperature to produce the polymer. Example of solvent includes water, alcohol, ketone, ether, ester, or acid. Example of initiator includes 1-hydroxy-cyclohexyl phenyl ketone, dicumyl peroxide, 2,5-bis(t-butylperoxy)-2,5-dimethylhexane, α,α-bis(t-butylperoxy)di-isopropylbenzene, or combinations of two or more thereof. If the initiator is a photoinitiator, a UV light can be used. The polymer produced may be cured by any means known to one skilled in the art such as by heat or a curing agent. Because the processes are well known, the description of which is omitted for the interest of brevity.

The PHA composition may comprise 0.01 to about 4%, about 0.1 to about 3%, about 0.5 to about 2%, based on the weight of the composition, of a nucleator including acids, esters, amides, or alcohols of the aliphatic radicals of length between 7 carbons and 22 carbons, or combinations of two or more thereof or can include a carboxylic acid or its derivative such as aromatic carboxylic acid (e.g., benzoic acid), aliphatic carboxylic acid (oleic acid, stearic acid, and behenic acid), acid derivative (stearyl alcohol, butyl stearate, stearamide, and behenamide), polycarboxylic acid, aliphatic hydroxycarboxylic acid, or combinations of two or more thereof. The carboxylic acids can be aliphatic, mono-functional (saturated, unsaturated, or multi-unsaturated) carboxylic acids thereof. The acid may have from about 10 to about 30, about 12 to about 28, about 16 to about 26, or 18 to 22, carbon atoms per molecule. Of particular interest are the acids that are on the US Food and Drug Administration (FDA) list as GRAS (generally regarded as safe). Examples of non-official GRAS acids include some mono- and some poly-carboxylic acids such as lactic acid, linoleic acid, malic acid, propionic acid, stearic acid, succinic acid, tannic acid, tartaric acid, or combinations of two or more thereof.

The composition can also include, by weight of the composition, about 0.01 to about 30, about 0.1 to about 20, or about 0.2 to about 10%, any other known impact modifier such as an ethylene copolymer, a core-shell polymer, or combinations thereof.

An ethylene copolymer may comprise repeat units derived from (a) ethylene; (b) one or more olefins of the formula CH₂═C(R³)CO₂R⁴, where R³ is hydrogen or an alkyl group with 1 to 6 carbon atoms, such as methyl, and R⁴ is glycidyl; and optionally (c) one or more olefins of the formula CH₂═C(R¹)CO₂R², or carbon monoxide where R¹ is hydrogen or an alkyl group with 1 to 8 carbon atoms and R² is an alkyl group with 1 to 8 carbon atoms, such as methyl, ethyl, or butyl. Repeat units derived from monomer (a) may comprise, based on the copolymer weight, from about 20, 40 or 50% to about 80, 90 or 95%. Repeat units derived from monomer (b) may comprise, based on the copolymer weight, from about 0.5, 2 or 3% to about 17, 20, or 25%. An example of the ethylene copolymer derived from ethylene and glycidyl methacrylate is referred to as EGMA. Optional monomers (c) can be butyl acrylates or CO. One or more of n-butyl acrylate, tert-butyl acrylate, iso-butyl acrylate, and sec-butyl acrylate may be used. An ethylene copolymer example is derived from ethylene, butyl acrylate, and glycidyl methacrylate (EBAGMA). Repeat units derived from monomer (c), when present, may comprise, based on the copolymer weight, from about 3, 15 or 20% to about 35, 40 or 70%.

If an ethylene glycidyl methacrylate copolymer is present in the composition, the carboxylic acid can be in the form of an alkyl ester or an alkyamide where the alkyl group has 4 to about 30 or 10 to about 20 carbon atoms.

A core/shell polymer preferably has a shell with Refractice Index in the visible region within 0.1 units of that of the PHA; the core comprises one or more elastomers that may comprise polyalkyl acrylate and be optionally cross-linked; the shell comprises non-elastomeric polymer that may include polymethyl methacrylate and optionally contain functional groups including epoxy, carboxylic acid, or amine.

A core-shell polymer may be made up of multiple layers, prepared by a multi-stage, sequential polymerization technique of the type described in U.S. Pat. No. 4,180,529. Each successive stage is polymerized in the presence of the previously polymerized stages. Thus, each layer is polymerized as a layer on top of the immediately preceding stage.

A PHA composition can comprise one or more additives including plasticizers, stabilizers, antioxidants, ultraviolet ray absorbers, hydrolytic stabilizers, anti-static agents, dyes or pigments, fillers, fire-retardants, lubricants, reinforcing agents such as flakes, processing aids, antiblock agents, release agents, and/or combinations of two or more thereof. Desirably, to preserve optical transparency, the additives should match the Refractive Index of the PHA at the wavelength of interest. PLA Refractive Index is 1.453 at 630 nm to 900 nm; therefore pentane diamine is within 0.1 units of matching its Refractive Index.

These additives may be present in the compositions, by weight, from 0.01 to 7%, or 0.1 to 2%. For example, the compositions may contain from about 1 to about 5% plasticizer; from about 0.1 to about 0.5% antioxidants and stabilizers; from about 1 to about 10% other solid additives; and/or from about 1 to about 20 weight % flame retardants. Examples of suitable, although opaque, other solid additives include pigments such as titanium oxide, microwave susceptors such as carbon or graphite, induction heated metals such as steel powder or transition metal oxide, and radio frequency heat-sealing sucseptors.

A thermoforming process comprises contacting a PHA composition or PHA with a modifier to produce a compound. The contacting can include mixing PHA and modifier (and any other ingredients, if present) till the modifier is substantially or even homogeneously dispersed. Any other known impact modifiers (e.g. ionomers, grafting agents) and additives may be also dispersed in the composition. Any mixing methods known in the art may be used. For example, the component materials may be mixed to substantially dispersed or homogeneous using a melt-mixer such as a single or twin-screw extruder, blender, Buss Kneader, double helix Atlantic mixer, Banbury mixer, roll mixer, etc., to give a resin composition.

The contacting can include a melt-mixing temperature in the range above the softening point of the PHA and below the depolymerization temperature of the PHA of about 100° C. to about 350° C., about 130° C. to about 275° C., or especially about 180° C. to about 230° C. at an ambient pressure or in the range of 0 to about 70 MPa or 0 to about 34 MPa. The condition creates sufficiently high shear history to disperse the modifier into small particles and distribute them uniformly through the melted PHA and sufficiently low shear history to avoid excessive loss of PHA molecular weight and its embrittlement. Shear history is the concept of the amount to shear over a duration of time. A melt experiences more shear history when it experiences high shear for a long time than when it experiences high shear for a short time. Similarly a melt experiences more shear history when it experiences medium shear for a time than when it experiences lower shear for a same time duration. The shear history of plastics processing equipment may be complicated by differing shear rates and duration times within the equipment for example in a size screw extruder producing pellets the screw has low shear rates and long durations within the channels of the screw but high screws rates and low durations between the screw and the walls of the extruder. In general sufficiently high shear history is achieved by use of about 2 minutes of mixing from introduction of the ambient temperature ingredients into a heated batch twin blade mixer using rotor blade mixer that may be co- or counter-rotating or the use of about 10:1 length to diameter ratio trilobal, co-rotating twin screw extruder using a screw that contains less than 10% length of screw elements that are either kneading blocks or reverse elements, the rest being forward conveying sections. For example, a sufficiently high shear history can result from use of at least 3 minutes on the batch unit and at least 20:1 L:D (length to diameter) ratio on the continuous unit and an excessively high shear history may result from more than 40 minutes in the batch unit or a 50:1 L:D ratio in the continuous unit. Other processing equipment can be used for melt mixing such as a single screw extruder, counter rotating twin screw extruder, or roll mill. Also useful processors may include bilobal twin screw extruders and single screw extruders with mixing torpedoes at the end of the screw. Furthermore the size of the optional modifier particles having unmatched refractive indexes with the PHA may be less than about 500 nm, less than about 300 nm, or even less than 80 nm for low haze. The difficulty of dispersing modifier to small sizes such as less than 150 nm may increase with amount of modifier used and its solubility in the PHA. In general more than about 2% modifier having an unmatched Refractive Index in the PHA may lead to excessive hazy blends. For example, more than 3% or more than about 5% may give too high a level of haze irrespective of the type of mixing used.

Alternatively, a portion of the component materials can be pre-mixed in a melt-mixer to form a Master Batch, and the rest of the component materials subsequently added and further melt-mixed until substantially dispersed or homogeneous.

The composition may be molded into articles using any melt-processing technique suitable for PHA provided the processing into the finished article is done in a manner to achieve and amorphous article or to achieve low haze with semi-crystallinity. Commonly used melt-molding methods known in the art to achieve low haze and crystallinity can include injection molding into cold molds to form an amorphous pre-form followed by blow molding or stretching. The compositions also may be melt-formed onto cold quenching surfaces into films by extrusion or calendaring to prepare amorphous cast film. Those cast film that are amorphous may be further thermoformed or stretched into articles and structures.

The compositions may also be used to form films, rods, profiles, sheets, fibers and filaments that may be unoriented and semicrystalline and having haze, or unoriented and amorphous semifinished articles that are transparent, or oriented and semicrystalline that are transparent from the melt such as blown film or at a later stage oriented by heating a nearly amorphous semifinished, injection molded or cast article such as by injection stretch blown molding or thermoforming.

The compositions may be formed into films or sheets by extrusion through either slot dies onto cold quenching surfaces to prepare cast films or sheets or annular dies having cooling air rings to prepare blown films or sheets followed by thermoforming into articles and structures that are oriented from the melt or at a later stage in the processing of the composition.

To achieve the full clarity and toughness benefit of the modifier, the making of any amorphous semi-finished article desirably avoids excessive crystallinity more than about 1% and the making of the finished article desirably avoids either high crystallinity above about 5% or excessively large crystals of PHA above about 100 nm for those parts of the article valuing transparency.

The composition can then be thermoformed in a mold by being preheated above T_{g} and below Tₘₑₗₜ (temperature at which the polymer melts) which can be about 30° C. to about 250° C., about 60° C. to about 150° C., about 65° C. to about 100° C., or about 65° C. to about 90° C., to produce a thermoformed article. The mold can be any mold known to one skilled in the art such as trays, cup, cap, bowl, or lid. For example, a mold can be made with aluminum and can be used for stretching (orientation) by application of vacuum from inside the mold to a heated sheet of PHA covering the top of the mold. Upon completion, the thermoformed article, especially the one where the PHA is modified with a modifier, can be held in the heated mold for about 1 to about 20 seconds, about 1 to about 15 seconds, about 1 to about 10 seconds, about 1 to about 5 seconds, or about 2 to about 4 seconds heat set the molded article.

Wishing not to be bound by theory, the mold temperature is higher than the polymer's T_{g}, or the molecules would not move no matter how long in the mold. Lowering the temperature increases the required time. For example, for a PHA having a T_{g} of 55° C. and a melting point of 150° C., holding at 80° C. for even 30 seconds may produce high shrinkage. Accordingly, the mold temperature is desirably higher than 150° C. below halfway between T_{g} and Tₘₑₗₜ so that the time in the mold is short. The mold temperature may also be lower than about 15° C. above halfway between T_{g} and Tₘₑₗₜ so that the articles are not deformed when removed from the mold. The absolute top temperature would be Tₘₑₗₜ. The molded article accordingly can be heat set at a temperature higher than about 15° C. below halfway between T_{g} and Tₘₑₗₜ such as about 90° C. to about 135° C., 95° C. to about 120° C., 95° C. to about 110° C., about 100° C., about 110° C., about 120° C., or about 135° C. for about 1 to about 30 seconds, about 1 to about 20 seconds, about 1 to about 15 seconds, about 1 to about 10 seconds, about 1 to about 5 seconds, or about 2 to about 4 seconds.

The resulting article can then be cooled rapidly to the Tg. For thick profiles, the cooling rate of the interior of the profile may be benefited by use of the coldest temperature practical on the exterior of the article. That temperature is desirably below the glass transition temperature of the PHA. For example, for PHA having a glass transition temperature of about 50° C. and sheeting thickness of about 700μ may benefit from using one-side quenching temperatures of 10° C. whereas 500μ sheet can be made amorphous using 20° C. one-sided quench conditions. Quench temperatures above about 40° C. may not be as useful because the melt contacting such surfaces can cool too slowly and/or shrink to such surfaces if the glass transition temperature is about 40° C. The exact minimum temperature may decrease when a PHA is used that is inherently slower at crystallizing or when a lower amount of modifier is used or when the article is cooled or quenched from all sides versus one side or when the Tg of the PHA is lower.

In processing the amorphous semi-finished article into a transparent and crystallized sheet, the amorphous article may be first heated by conductive, convective, or radiative heating. With radiative heating, the article is exposed to black-body radiation temperatures ranging from 200° C. to about 700° C. Time in a 230° C. black body radiator may range from about 10 to about 70 seconds, or 20 to 60 seconds, or 30 to 50 seconds for a 600μ thick profiles heated from both sides. The optimal temperature for the semi-finished article for achieving crystallinity and clarity in the next step is about half way between the glass transition and the melt point for the particular PHA used.

In forming the heated amorphous semifinished article into a finished transparent, crystalline article the semi-finished article may be stretched at sufficiently high speeds and high stretch ratios to cause crystallization and to enable those crystallites to be small enough to not cause haze. Stretch rate may be about 10% to about 1000% per second, or between 20% per second and 600% per second. Stretch ratios may be about 20% (post stretch length is 150% of the pre-stretched dimension) to about 800%, or 50% to 700%, or 100% to 300%. Not wishing to be bound by theory, slow stretch rates may give haze or incompletely formed articles and too high stretch rates may give insufficiently high crystallinity resulting in finished articles which have poor dimensional stability above the glass transition temperature. Low stretch ratios may not induce enough crystallinity within the short time of the thermoforming process or cause haze in the finished article and too high a stretch ratio may cause excessive thinning or tearing of the article. The exact stretch ratio may be higher for unbalanced or one-dimensional stretching or articles which not cooled during the stretching operation such as is the case for vacuum, pressure-assisted, or no physical “plug assistance”. Otherwise those parts of the article that are cooled during the stretch operation may experience haze or poor dimensional stability. An article produced desirably has a haze of from about 2% haze to about 20%, or about 5 to about 15%, haze per 30 mil thickness. An article can include article film, sheet, fiber, filament, lidding film, blown film, or combinations of two or more thereof.

The film may be a single layer of the PHA composition (a monolayer sheet) or a multilayer film or sheet comprising a layer of the PHA composition and at least one additional layer comprising a different material.

For packaging applications, a multilayer film may involve three or more layers including an outermost structural or abuse layer, an inner or interior barrier layer, and an innermost layer making contact with and compatible with the intended contents of the package and capable of forming any needed seals. Other layers may also be present to serve as adhesive layers to help bond these layers together. The thickness of each layer can range from about 10 to about 200 μm.

The outermost structural or abuse layer may be prepared from the PHA composition. Additional structure layers may include oriented polyester or oriented polypropylene, but can also include oriented polyamide (nylon). The structure layer can be printed, for example, by reverse printing using rotogravure methods.

The inner layer can include one or more barrier layers to reduce the permeation rate through the layer by agents such as water, oxygen, carbon dioxide, electromagnetic radiation such as ultraviolet radiation, and methanol that potentially can affect the product inside therein. Barrier layers can comprise, for example, metallized polypropylene or polyethylene terephthalate, ethylene vinyl alcohol, polyvinyl alcohol, polyvinylidene chloride, aluminum foil located so as not to interfere with the optical value of the PHA such as to read-through to the print layer, silicon oxides (SiOₓ), aluminum oxide, aromatic nylon, blends or composites of the same as well as related copolymers thereof.

The innermost layer of the package can be the sealant and can be a polymer layer or coating that can be bonded to itself (sealed) or other film or substrate at temperatures substantially below the melting temperature of the outermost layer. Sealants are well known and can be commercially available from E. I. du Pont de Nemours and Company (DuPont), Wilmington, Del. Substrate can include foil, paper or nonwoven fibrous material.

A multilayer film can be produced by any methods well known to one skilled in the art such as, for example, coextrusion and can be laminated onto one or more other layers or substrates. Other suitable converting techniques are, for example, blown film (co)extrusion and extrusion coating.

Films can be used to prepare packaging materials such as containers, pouches and lidding, balloons, labels, tamper-evident bands, or engineering articles such as filaments, tapes and straps.

The disclosure uses film as example and is applicable to sheet, which is thicker than film.

The article can be in other forms such as shaped articles or molded articles. Containers and packaging materials can be of various shapes including trays, cups, caps, bowls, or lids prepared from sheets by vacuum or pressure forming. Other shapes include those prepared by deep drawing an unstretched sheet (i.e. thermoforming), by extrusion blow molding or biaxial stretching blowing parisons (injection stretch blow molding), by injection molding, compression molding or other molding processes; profile extruded articles; carton; squeezable tubes, pouches or bottles; components of containers; bags or pouches within a rigid container that dispense liquids such as wine, medical fluids, baby formula; clam shells, and blister packs.

The thermoformed article can be recovered by any methods known to one skilled in the art.

A film or sheet could be thermoformed to produce a concave surface such as a tray, cup, can, bucket, tub, extruded cast tube, clamshell, dish, plates, lids, box, or bowl. Thermoformed articles may be combined with additional elements, such as a generally planar film sealed to the thermoformed article that serves as a lid (a lidding film).

Products that can be packaged include food and non-food items including beverages (e.g., carbonated beverages, orange juice, apple juice, grape juice, other fruit juices and milk), solid foods (e.g., meats, cheese, fish, poultry, nuts, coffee, applesauce or other sauces, stews, dried fruit, food paste, soups and soup concentrates and other edible items), spices, condiments (e.g., ketchup, mustard, and mayonnaise), pet food, cosmetics, personal care products (e.g., toothpaste, shaving foam, soaps, shampoos, lotions and the like), pharmaceuticals, fragrances, electronic components, industrial chemicals or household chemicals (e.g., laundry detergent, fabric softener), agrochemicals, medical devices and equipment, medicinal liquids, fuels, and biological substances.

Films may also be slit into narrow tapes and drawn further to provide slit film fibers for use as degradable sutures.

The following Examples are illustrative, and are not to be construed as limiting the scope of the invention.

### EXAMPLES

The example illustrates the invention in making thermoformed cups.

### Materials

n-Butyl acrylate, inhibited with 10-55 ppm MEHQ (monomethyl ether quinone), Dow Chemical (Midland, Mich.), reagent grade; isobutyl acrylate, inhibited with 10-55 ppm MEHQ (BASF), reagent grade; ethyl acrylate, inhibited with 10-20 ppm MEHQ, made by Aldrich (Milwaukee, Wis.), 99% purity; glycidyl methacrylate, inhibited with 75-100 ppm MEHQ (Dow Chemical), reagent grade; 1-hydroxy-cyclohexyl phenyl ketone (Irgacure 184; photoinitiator; Ciba Specialty Chemical Company; Tarrytown, N.Y.); and PLA2002D pellets (NatureWorks LLC, Minnetonka, Minn.; having a melt viscosity about 1500 Pa·s (190° C. and 100 s⁻¹; Tg, 55° C.).

### Methods

UV source was a Model UVELMS 8 Unit (Entela; Dover, Ohio) with 8 watt bulb labeled “365 nm”.

Batch blender was a Haake Rheocord 90 using roller blade rotors at 125 rpm and a 55 g mixing chamber operated by preheating the unit to goal melt temperature, then running rotors, starting the clock, charging about 55 g of ingredients within about a 15 second period, closing the lid, and mixing for 5 minutes. When complete the melt mass was discharged onto a cold container, cooled to ambient and containered.

The impact modifiers were polymerized based on a 10 g batch size of monomer solution. Based on the percent composition of the desired polymer, the monomers were weighed out in a 20 ml scintillation vial. Irgacure 184 was added to the 10 g monomer solution equating to a quantity of 0.31 g (final 3 weight %) and the solution was swirled until the Irgacure 184 was dissolved. A section of FEP (fluorinated ethylene propylene) film was folded and configured into a boat. The sides were held together with staples. The boat was placed into a 5.5-inch diameter Pyrex petri dish and the monomer solution was poured into the boat. The lid was placed over the petri dish and duct tape was used to hold the lid down tightly over the sample. The petri dish was placed on a small lab jack and the jack was placed under an Entela 8 watt 365 nm ultraviolet light. The sample was jacked up such that it was 1.5 inches from the bottom of the lamp. The lamp was turned on for a period of 15 hours to polymerize the monomer solution. After the 15 hour soak time, the cured polymer was removed from the FEP boat and was used in subsequent PLA compositions. If the inhibitors were removed from the monomers, the cure time would have been greatly reduced.

The PLA blends with individual polymers were prepared on a Farrel 2 roll mill. This mill had 3-inch diameter rolls that were each 6-inch in length. The front roll was set for 125° C. and the back roll for 165° C. A 75 g batch size was used and the total processing time was 7 minutes. The compounding was done according to standard art. This mill has a fixed gear ratio of 1.4:1, resulting in a speed of 37 RPM for the primary roll (front roll) and 26.4 RPM for the secondary roll (back roll). Example A and comparative examples A, B, and C, were prepared on the Haake mixer. The remaining samples were made on the roll mill. The physical properties of the polymers did not appear effected by using the different preparation methods.

Elongations were conducted on an Instron Series IX instrument (Instron Corp, Norwood, Mass.) using a microtensile bar ASTM D-638 Type IV shape with “w” at 0.18 in (0.46 cm), “L” at 0.5 in (1.27 cm), and “L0” at 1.5 in (0.38 cm). Five samples were tested and any samples having much lower elongations were discarded.

Haze was assessed using a Gardner “Haze Gard plus” (ASTM D1003 rev 92). The haze was reported as “total haze”. The modified PLA was compression molded into a 0.03 inch thick plaque at 190° C. and was slowly cooled over a period of 7 minutes to produce an amorphous plaque. The haze data is reported with corresponding thicknesses.

### Example A

Liquid nBA (n-butyl acrylate; 9 g) was hand-mixed with GMA (glycidyl methacrylate; 1 g) in an 100-ml screw top glass jar followed by adding thereto 3% Irgacure 184 ( 0.31 g). The n-butyl acrylate/glycidyl methacrylate solution, with 3% Irgacure (as based on the 10 g monomer solution) produced as disclosed above was poured into a boat disclosed above folded from FEP that was sitting in a 5.5 inch diameter glass Petri dish disclosed above. The dish was exposed with a UV source from above and 1.5 inches away for 15 hours to produce poly(90%butylacrylate/10% glycidyl methacrylate that was not fluid and was very sticky.

PLA2002D (52.3 g) was mixed with the poly(90%butyl acrylate/10% glycidyl methacrylate) (2.7 g) at a melt temperature of 205° C. for 5 minutes to produce a PLA composition which was cooled to 23° C. The cooled PLA composition was compression molded at 190 C using a 3-inch by 4-inch template 30-mils thick. The modified PLA sample was sandwiched between two FEP sheets, 10 mils thick to provide a smooth surface. The template, together with the FEP sandwich and PLA sample was placed between two 8 inch by 8 inch by ¼ inch thick steel plates, which in turn were placed in a laboratory hydraulic press, to which the platens were preheated to a temperature of 190 C. The platens were raised such that a slight pressure was applied to the sample assembly. This position was held for a period of 4 minutes, at which time a force of 25 tons was applied to the platens for 1 minute. Cooling water was circulated through the platens to cool them to 25 C over a period of 7 minutes. The modified PLA sample was removed from the sample template and was amorphous as determined by the controlled, slow cool down period. The cooled plaque was die cut into microtensile bars. (ASTM D-638)

Elongation to break was determined by Instron pull of the dogbone at 1 inch/minute at ambient conditions (about 25° C.). Total haze was determined by testing a sheet sample.

### Comparative Example A

The modifier was a polybutylacrylate, prepared as in Example A except it started with 100% nBA. Blends of 10% of the modifier and 90% PLA2002D were prepared as in Example A and similarly tested.

### Comparative Example B

The modifier was polyethylacrylate, prepared as in Example A except it started with 100% ethylacrylate. Blends of 5% of the modifier and PLA2002D were prepared and tested.

### Example B

The modifier was polyethyl acrylate glycidyl methacrylate and this example was prepared on the roll mill as described above. The modifier composition was 95% ethylacrylate and 5% GMA. Blends of 5% of the modifier and 95% PLA2002D were prepared and tested.

### Example C

The modifier was poly(ethyl acrylate glycidyl methacrylate), prepared as in Example B except that 90% ethylacrylate and 10% GMA were used. The modifier had a T_{g} of −21° C. and was less sticky than that of Example A. Blends of 5% of the modifier and 95% PLA2002D were prepared and tested.

### Example D

The modifier was poly(ethylacrylate glycidyl methacrylate), prepared as in Example B except that 90% ethylacrylate and 10% GMA were used. The modifier had a T_{g} of −21° C. and was less sticky than that in Example A. Blends of 10% of the modifier and 90% PLA2002D were prepared and tested.

### Comparative Example C

The modifier was polyisobutylacrylate, prepared as in Example A except that 100% isobutylacrylate was used. Blends of 10% of the modifier and 90% PLA2002D were prepared and tested.

### Example E

The modifier was poly(isobutyl acrylate glycidyl methacrylate), prepared as in Example B except that 90% isobutylacrylate and 5% GMA were used. The modifier had a T_{g} of −40° C. Blends of 5% of the modifier and 95% PLA2002D were prepared and tested.

### Example F

The modifier was poly(isobutyl acrylate glycidyl methacrylate), prepared as in Example B except that 90% isobutylacrylate and 10% GMA were used. The modifier had a T_{g} of −34° C. Blends of 5% of the modifier and 95% PLA2002D were prepared and tested.

### Example G

Same modifier as Example F except that blends of 10% with PLA2002D were produced.

### Comparative Example D

The modifier was copolymer of ethylene (40%), methyl acrylate (55%), and glycidyl methacrylate (5%), prepared according to standard art in a high pressure reactor. Blends of 5% of the modifier and 95% of PLA 2002D were prepared as in Example B and tested.

### Comparative Example E

Same modifier as Comparative Example F except that blends of 10% with PLA 2002D were produced.

### Comparative Example F

The modifier was copolymer of ethylene (38%), methyl acrylate (55%), and glycidyl methacrylate (7%), prepared according to standard art in a high pressure reactor. Blends of 5% of the modifier and 95% PLA 2002D were prepared as in Example B and tested.

The results of the tests are shown in the following Table 1, which shows that all invention examples had lower haze (better optical clarity) and higher elongation than the comparative examples.

| | Haze (%) | Elongation (%) |
|---|---|---|
| Example A | 12 | 190 |
| Comparative Example A | 42 | 9 |
| Comparative Example B | 27 | 4 |
| Example B | 8 | 45 |
| Example C | 8 | 160 |
| Example D | 9 | 210 |
| Comparative Example C | 23 | 80 |
| Example E | 9 | 210 |
| Example F | 12 | 140 |
| Example G | 18 | 215 |
| Comparative Example D | 43 | 65 |
| Comparative Example E | 57 | 190 |
| Comparative Example F | 38 | 46 |

1. A composition comprising or produced from poly(hydroxyalkanoic acid), an impact modifier, and optionally a nucleator wherein
the poly(hydroxyalkanoic acid) comprises repeat units derived from 6-hydroxyhexanoic acid, 3-hydroxyhexanoic acid, 4-hydroxyhexanoic acid, 3-hydroxyheptanoic acid, or combinations of two or more thereof;
the modifier is present in the composition from about 0.1 to about 50%, based on the weight of the composition and comprises repeat units derived from an alkyl acrylate and a comonomer;
the alkyl can include 1 to about 10 carbon atoms per group; and
the comonomer includes (meth)acrylic acid, maleic acid, maleic anhydride, glycidyl methacrylate, gycidyl acrylate, carbon monoxide, or combinations of two or more thereof.

2. The composition of claim 1 wherein
the poly(hydroxyalkanoic acid) comprises repeat units derived from hydroxyalkanoic acids having five or fewer carbon atoms;
the modifier is present in the composition from about 0.5% to about 30%;
the alkyl group includes ethyl acrylate, propyl acrylate, isopropyl acrylate, n-butyl acrylate, tert-butyl acrylate, iso-butyl acrylate, sec-butyl acrylate, amyl acrylate, or combinations of two or more thereof; the comonomer includes glycidyl methacrylate, glycidyl acrylate, or combinations thereof; and
the acid moiety, or portion thereof, of the modifier is optionally neutralized with a metal ion.

3. The composition of claim 2 wherein
the poly(hydroxyalkanoic acid) comprises repeat units derived from glycolic acid, lactic acid, 3-hydroxypropionic acid, 2-hydroxybutyric acid, 3-hydroxybutyric acid, 4-hydroxybutyric acid, 3-hydroxyvaleric acid, 4-hydroxyvaleric acid, 5-hydroxyvaleric acid, or combinations of two or more thereof;
the modifier is present in the composition from about 0.5 to about 30% and comprises repeat units derived from the comonomer;
the alkyl group includes ethyl acrylate, n-butyl acrylate, iso-butyl acrylate, or combinations of two or more thereof; and
the nucleator includes fatty acids, fatty acid derivatives, polyacetal, polyacetal copolymers, or poly(hydroxyalkanoic) acid isomer or copolymers having melt points 30° C. or more above the melt point of the base poly(hydroxyalkanoic) acid.

4. The composition of claim 3 wherein
the composition comprises 0.01 to 4% of the nucleactor including acids, esters, amides, or alcohols, or combinations of two or more thereof;
the poly(hydroxyalkanoic acid) comprises poly(glycolic acid), poly(lactic acid), poly(hydroxy-butyric acid), poly(hydroxy-butyrate-valerate) copolymer, copolymer of glycolic acid and lactic acid, hydroxyvaleric acid, 5-hydroxyvaleric acid, or combinations of two or more thereof;
the modifier is present in the composition from about 0.5 to about 20%;
the alkyl group includes ethyl acrylate or n-butyl acrylate; and
the comonomer is glycidyl methacrylate.

5. The composition of claim 4 wherein the poly(hydroxyalkanoic acid) comprises the poly(lactic acid) and the modifier is poly(butyl acrylate glycidyl methacrylate), poly(ethyl acrylate glycidyl methacrylate), poly(isobutyl acrylate glycidyl methacrylate), or combinations of two or more thereof.

6. The composition of claim 5 wherein the modifier is poly(butyl acrylate glycidyl methacrylate.

7. The composition of claim 5 wherein the modifier is poly(ethyl acrylate glycidyl methacrylate).

8. The composition of claim 5 wherein the modifier is poly(isobutyl acrylate glycidyl methacrylate).

9. The composition of claim 5 wherein the nucleator includes stearic acid, behenic acid, behenamide, or combinations of two or more thereof and the modifier is poly(butyl acrylate glycidyl methacrylate, poly(ethyl acrylate glycidyl methacrylate), poly(isobutyl acrylate glycidyl methacrylate), or combinations of two or more thereof.

10. An article comprising or produced from a composition wherein the composition is as recited in claim 1.

11. The article of claim 10 wherein
the poly(hydroxyalkanoic acid) comprises repeat units derived from hydroxyalkanoic acids having five or fewer carbon atoms;
the modifier is present in the composition from about 0.5% to about 30%;
the alkyl group includes ethyl acrylate, propyl acrylate, isopropyl acrylate, n-butyl acrylate, tert-butyl acrylate, iso-butyl acrylate, sec-butyl acrylate, amyl acrylate, or combinations of two or more thereof; the comonomer includes glycidyl methacrylate, glycidyl acrylate, or combinations thereof; and
the acid moiety, or portion thereof, of the modifier is optionally neutralized with a metal ion.

12. The composition of claim 11 wherein
the poly(hydroxyalkanoic acid) comprises repeat units derived from glycolic acid, lactic acid, 3-hydroxypropionic acid, 2-hydroxybutyric acid, 3-hydroxybutyric acid, 4-hydroxybutyric acid, 3-hydroxyvaleric acid, 4-hydroxyvaleric acid, 5-hydroxyvaleric acid, or combinations of two or more thereof;
the modifier is present in the composition from about 0.5 to about 30% and comprises repeat units derived from the comonomer;
the alkyl group includes ethyl acrylate, n-butyl acrylate, iso-butyl acrylate, or combinations of two or more thereof; and
the nucleator includes fatty acids, fatty acid derivatives, polyacetal, polyacetal copolymers, or poly(hydroxyalkanoic) acid isomer or copolymers having melt points 30° C. or more above the melt point of the base poly(hydroxyalkanoic) acid.

13. The composition of claim 12 wherein
the composition comprises 0.01 to 4% of the nucleactor including acids, esters, amides, or alcohols, or combinations of two or more thereof;
the poly(hydroxyalkanoic acid) comprises poly(glycolic acid), poly(lactic acid), poly(hydroxy-butyric acid), poly(hydroxy-butyrate-valerate) copolymer, copolymer of glycolic acid and lactic acid, hydroxyvaleric acid, 5-hydroxyvaleric acid, or combinations of two or more thereof;
the modifier is present in the composition from about 0.5 to about 20%;
the alkyl group includes ethyl acrylate or n-butyl acrylate; and
the comonomer is glycidyl methacrylate.

14. The composition of claim 13 wherein the poly(hydroxyalkanoic acid) comprises the poly(lactic acid) and the modifier is poly(butyl acrylate glycidyl methacrylate), poly(ethyl acrylate glycidyl methacrylate), poly(isobutyl acrylate glycidyl methacrylate), or combinations of two or more thereof.

15. The composition of claim 14 wherein the nucleator includes stearic acid, behenic acid, behenamide, or combinations of two or more thereof and the modifier is poly(butyl acrylate glycidyl methacrylate, poly(ethyl acrylate glycidyl methacrylate), poly(isobutyl acrylate glycidyl methacrylate), or combinations of two or more thereof.

16. The article of claim 11 wherein the article is a film, sheet, fiber, filament, lidding film, or combinations of two or more thereof.

17. The article of claim 15 wherein the article is a film, sheet, fiber, filament, lidding film, or combinations of two or more thereof.

18. The article of claim 15 wherein the article is tray, cup, can, bucket, tub, box, bowl, lid, oriented tube, extruded cast tube, blown tube, clamshell, dish, plate, or combinations of two or more thereof.

19. A process comprising contacting a poly(hydroxyalkanoic acid) with an impact modifier under a condition effective to produce a composition and thermoforming or injection molding the composition to produce an article wherein the composition is as recited in claim 1 and the article has a haze of from about 2% haze per 30 mil thickness to about 20% haze per 30 mil thickness.
